(19) United States
(12) Patent Application Publication
(10) Pub. No.: US 2014/0098042 A1
(43) Pub. Date: Apr. 10, 2014

(54) TOUCH PANEL

(71) Applicant: HON HAI PRECISION INDUSTRY CO., LTD., New Taipei (TW)

(72) Inventors: YAO-CHENG KUO, New Taipei (TW); KUO-CHIH YU, New Taipei (TW); CHENG-CHI WU, New Taipei (TW)

(73) Assignee: HON HAI PRECISION INDUSTRY CO., LTD., New Taipei (TW)

(21) Appl. No.: 14/037,381

(22) Filed: Sep. 26, 2013

(30) Foreign Application Priority Data
Oct. 9, 2012 (TW) 101137235

(51) Int. Cl. G06F 3/01

(52) U.S. Cl. CPC G06F 3/016
USPC 345/173

(57) ABSTRACT

A touch panel includes a first substrate, an electronic circuit board, a second substrate, and a number of touch-sensing members arranged on the electronic circuit board. Each of the touch-sensing members comprises a metal dome, an insulating layer covering the metal dome, and a sensing layer formed on the insulating layer. A number of contacting tabs are arranged on the electronic circuit board corresponding to each of the metal domes. The sensing layer generates a first signal in a touch mode when the touch panel is touched by a conductor. The contacting tab generates a second signal in a button mode when the second substrate is deformed when the second substrate is pressed, and the metal dome comes into contact with the contacting tab.

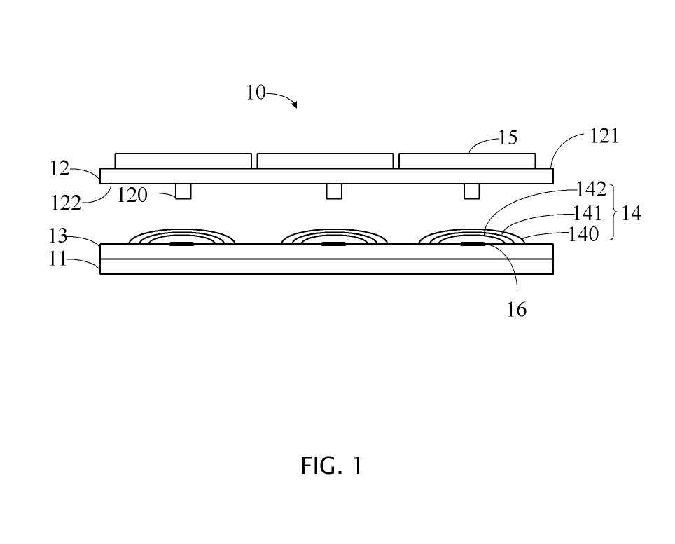

### BACKGROUND

1. Technical Field

The present disclosure relates to input devices, and particularly to a touch panel providing tactile feedback.

2. Description of Related Art

Many electronic devices have input devices. Two usual input methods are buttons and touch panels. The buttons have the benefit of providing tactile feedback when pressed, such as clicking or resisting being pressed when the button has been pressed far enough. However, the appearance of buttons on an electronic device is not as aesthetic as touch panels. On the other hand, a touch panel is more aesthetic, but does not provide the tactile feedback of buttons and may feel unsatisfactory to a user.

Therefore, what is needed is a touch panel having an aesthetic appearance and providing tactile feedback when pressed.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

The drawing is a schematic, cross-sectional view showing a touch panel, according to an exemplary embodiment.

### DETAILED DESCRIPTION

The disclosure, including the accompanying, is illustrated by way of example and not by way of limitation. It should be noted that references to “an” or “one” embodiment in this disclosure are not necessarily to the same embodiment, and such references mean “at least one.”

Referring to the drawing, a touch panel 10 according to an exemplary embodiment is illustrated. The touch panel 10 includes a first substrate 11, a second substrate 12, a circuit board 13, and a number of touch-sensing members 14. The second substrate 12 further includes a number of pressing portions 15. The pressing portions 15 are arranged on a top surface 121 of the second substrate 12, and a number of contacts 120, which spatially correspond to the pressing portions 15 respectively, are arranged on a bottom surface 122 of the second substrate 12 opposite to the top surface 121. The electronic circuit board 13 is arranged on the first substrate 11 and faces the bottom surface 122 of the second substrate 12.

The touch-sensing members 14 are arranged on the electronic circuit board 13 and correspond to the contacts 120 one to one. In this embodiment, a contact 120 is a protrusion projecting from the bottom surface 122 of the second substrate 12. Each of the pressing portions 15 is a protruding key arranged on the second substrate 12. In another embodiment, the pressing portions 15 are a number of patterns formed on the top surface 121 of the second substrate 12

In this embodiment, the second substrate 12 is made of rubber, plastic, or other suitable elastic materials. Each of the touch-sensing members 14 includes a metal dome 142, an insulating layer 141 covering the metal dome 142, and a sensing layer 140 formed on the insulating layer 141. The metal dome 142 and the sensing layer 140 are electronically connected to the electronic circuit board 13. A number of contacting tabs 16 is arranged on the electronic circuit board 13 and aligned with the corresponding metal domes 140.

The insulating layer 141 is made of insulating material, such as rubber or polyethylene, and is arranged between the metal dome 142 and the sensing layer 140. In this embodiment, the sensing layer 140 is a silver paste coating printed on an outer surface of the insulating layer 141.

In a touch mode, when a conductor, such as a human finger or a touch pen, touches the second substrate 12, a capacitor is dynamically formed between the conductor and the related sensing layer 140 corresponding to the touch point, thereby changing the electrical current in the sensing layer 140 and generating a first signal. The touch position is determined from the change in the capacitance as measured from the sensing layer 140.

In a button mode, when a pressing portion 15 of the second substrate 12 is pressed by a user, the second substrate 12 is deformed, causing the contact 120 corresponding to the pressed point to press the sensing layer 140 of the touch-sensing member 14. The metal dome 142 then deforms and contacts the contacting tab 16, thereby generating a second signal. The pressed point is then determined based on the second signal.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A touch panel comprising:
a first substrate;
a circuit board arranged on the first substrate;
an elastic second substrate;
a plurality of touch-sensing members arranged on the circuit board;
wherein each of the touch-sensing members comprises a metal dome, an insulating layer covering the metal dome, and a sensing layer formed on the insulating layer; a plurality of contacting tabs arranged on the circuit board and aligned with the corresponding metal domes; the sensing layer generates a first signal when the touch panel is touched by a conductor; the second substrate is deformed when the second substrate is pressed, the metal dome comes into contact with the corresponding contacting tab as urged by the second substrate, thereby generating a second signal.

2. The touch panel as described in claim 1, wherein the second substrate comprises a plurality of pressing portions arranged on a top surface of the second substrate, and a plurality of contacts; wherein the contacts spatially correspond to the pressing portions respectively, and are arranged on a bottom surface of the second substrate opposite to the top surface; the contact corresponding to the pressed point causes the metal dome to deform and contact the corresponding contacting tab.

3. The touch panel as described in claim 1, wherein the second substrate is made of rubber or plastic.

4. The touch panel as described in claim 2, wherein each of the pressing portions is a protruding keypad arranged on the top surface of the second substrate.

5. The touch panel as described in claim 2, wherein each of the pressing portions is a pattern formed on the top surface of the second substrate.

6. The touch panel as described in claim 1, wherein the insulating layer is made of rubber or polyethylene.

7. The touch panel as described in claim 1, wherein the sensing layer is a silver paste coating printed on the insulating layer.
